(19) United States
(12) Patent Application Publication
(10) Pub. No.: US 2015/0154529 A1
(43) Pub. Date: Jun. 4, 2015

(54) METHODS AND SYSTEMS FOR CREATING A TASK

(71) Applicant: Xerox Corporation, Norwalk, CT (US)

(72) Inventors: Preethi Raj Raajaratnam, Tamil Nadu (IN); Shourya Roy, Bangalore (IN)

(73) Assignee: Xerox Corporation, Norwalk, CT (US)

(21) Appl. No.: 14/094,820

(22) Filed: Dec. 3, 2013

(51) Int. Cl. G06Q 10/06; G06Q 10/10

(52) U.S. Cl. CPC G06Q 10/063114; G06Q 10/1097

(57) ABSTRACT

Methods and systems for creating a task are provided. A request from a worker is received to perform the task. A task is created in response to the request. The task comprises at least one new sub-task and at least one additional sub-task, wherein the at least one additional sub-task is selected from a set of unfinished sub-tasks associated with one or more previously attempted tasks. The task is communicated to the worker. The worker may receive a bonus remuneration for correctly attempting the at least one additional sub-task.

### TECHNICAL FIELD

The presently disclosed embodiments are related, in general, to crowdsourcing. More particularly, the presently disclosed embodiments are related to methods and systems for creating a task.

### BACKGROUND

Crowdsourcing has emerged as a convenient and an economical method for organizations to outsource certain tasks, which require human involvement. For example, tasks such as digitization of a handwritten document, labeling of an image, and anomaly detection in a video may be uploaded by a requester on one or crowdsourcing platforms. Crowdworkers associated with the crowdsourcing platforms may attempt such tasks. Generally, the task presented to a crowdworker includes one or more sub-tasks. Such sub-tasks may have been clubbed together based on the type of the sub-tasks. For example, one or more sub-tasks corresponding to digitization of a handwritten document may be clubbed together to form the task.

The requestor may upload multiple instances of such tasks so that multiple crowdworkers can work on the same task. The responses received from the said multiple crowdworkers can be compared to validate the task accordingly. Usually, if consensus on any of the sub-tasks in the task is not achieved, the whole task is uploaded again on the crowdsourcing platform. This may result in time overhead for the requestor.

In addition, when the task is uploaded on the crowdsourcing platform for the first time, a large number of crowdworkers may show interest to attempt the task. In a scenario, when the consensus on any of the sub-task is not achieved, the complete task is uploaded on the crowdsourcing platform again. Therefore, less number of crowdworkers may be interested to attempt the task that has been uploaded for the second time in comparison to the number of crowdworkers that were initially interested to attempt the task.

### SUMMARY

According to embodiments illustrated herein there is provided a method for creating a task. The method includes receiving, by one or more processors, a request from a worker to perform the task. The method further includes creating, by the one or more processors, the task in response to the request. The task comprises at least one new sub-task and at least one additional sub-task, wherein the at least one additional sub-task is selected from a set of unfinished sub-tasks associated with one or more previously attempted tasks. The task is communicated to the worker by the one or more processors. The worker may receive a bonus remuneration for correctly attempting the at least one additional sub-task.

According to embodiment illustrated herein there is provided a system for creating a task. The system includes one or more processors operable to receive a request from a worker to perform the task. The one or more processors are further operable to create the task, in response to the request. The task comprises at least one new sub-task and at least one additional sub-task, wherein the at least one additional sub-task is selected from a set of unfinished sub-tasks associated with one or more previously attempted tasks. Additionally, the one or more processors are operable to communicate the task to the worker. The worker may receive a bonus remuneration for correctly attempting the at least one additional sub-task.

According to embodiments illustrated herein there is provided a computer program product for use with a computing device. The computer program product comprises a non-transitory computer readable medium that stores a computer program code for creating a task. The computer program code is executable by one or more processors in the computing device to receive a request from a worker to perform the task. The computer program code is further executable by one or more processors in the computing device to create the task, in response to the request. The task comprises at least one new sub-task and at least one additional sub-task, wherein the at least one additional sub-task is selected from a set of unfinished sub-tasks associated with one or more previously attempted tasks. The task is communicated to the worker. The worker may receive a bonus remuneration for correctly attempting the at least one additional sub-task.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit, the scope in any manner, wherein like designations denote similar elements, and in which:

FIG. 1 is a block diagram illustrating a system environment in which various embodiments can be implemented;

FIG. 2 is a block diagram of a system for creating a task, in accordance with at least one embodiment;

FIG. 3 is a flowchart illustrating a method for creating a task, in accordance with at least one embodiment;

FIG. 4 is a flowchart illustrating a method to select an additional sub-task from a pool of sub-tasks, in accordance with at least one embodiment;

FIG. 5 is a snapshot of a dummy task, in accordance with at least one embodiment; and

FIG. 6 is a flow diagram illustrating the process of creation of a task, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes, as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

A “task” refers to a piece of work, an activity, an action, a job, an instruction, or an assignment to be performed. Tasks may necessitate the involvement of one or more workers. In an embodiment, a task includes one or more sub-tasks that have been clubbed together based on the type of sub-tasks. Examples of the type of sub-tasks may include, but are not limited to, digitization of a document, generating a report, evaluating a document, conducting a survey, writing a code, extracting data, translating text, and the like.

“Crowdsourcing” refers to distributing tasks by soliciting the participation of loosely defined groups of individual crowdworkers. A group of crowdworkers may include, for example, individuals responding to a solicitation posted on a certain website such as, but not limited to, Amazon Mechanical Turk and Crowd Flower.

A “crowdsourcing platform” refers to a business application, wherein a broad, loosely defined external group of people, communities, or organizations provides solutions as outputs for any specific business processes received by the application as input. In an embodiment, the business application may be hosted online on a web portal (e.g., crowdsourcing platform servers). Various examples of the crowdsourcing platforms include, but are not limited to, Amazon Mechanical Turk or Crowd Flower.

A “crowdworker” refers to a workforce/worker(s) that may perform one or more tasks, which generate data that contributes to a defined result. According to the present disclosure, the crowdworker(s) includes, but is not limited to, a satellite center employee, a rural business process outsourcing (BPO) firm employee, a home-based employee, or an internet-based employee. Hereinafter, the terms “crowdworker”, “worker”, “remote worker” “crowdsourced workforce”, and “crowd” may be interchangeably used.

A “profile of crowdworker” refers to a collection of information pertaining to the crowdworker and the type of work that the crowdworker has attempted. In an embodiment, the profile includes information related to expertise of the crowdworker, type of tasks previously taken up by the crowdworker, number of tasks that crowdworker has previously attempted, competency score of the crowdworker in attempting the task. In addition to the information pertaining to the tasks, the profile may also include interests/hobbies, age, ethnicity, and other demographic information of the crowdworker.

An “unfinished sub-task” refers to a sub-task in a task that has either not been attempted by any of the crowdworkers or has been wrongly attempted by the one or more crowdworkers.

“Task complexity” refers to a measure of difficulty level associated with a task. In an embodiment, the task complexity is directly proportional to a number of times a task has been wrongly attempted by the one or more crowdworkers. In another embodiment, the task complexity is directly proportional to a level of expertise required by a crowdworker to attempt the task.

A “hyperlink” refers to a reference to a data that a reader can follow or that is followed automatically. The text portions included in the hyperlink are referred as hypertext.

A “dummy task” refers to a virtual task that is presented to a crowdworker. In an embodiment, the dummy task does not itself include any task or sub-task that can be attempted by the crowdworker. The dummy task includes a brief description of the task that the crowdworker may have in hand if they choose to attempt so. The dummy task further presents an option to the crowdworker to attempt bonus sub-tasks. In an embodiment, the crowdworker may or may not opt to attempt the bonus sub-tasks. Further, the dummy task includes a hyperlink that directs to the crowdworker to the actual task. In an embodiment, the act of clicking on the hyperlink is equivalent to accepting to attempt the task associated with the dummy task.

A “competency score” refers to a score given to a crowdworker based on a ratio of a number of sub-tasks that the crowdworker has correctly attempted to the total number of sub-tasks attempted by the crowdworker till date.

A “required accuracy score” refers a competency score that a crowdworker needs to posses in order to attempt a sub-task. In an embodiment, a requestor, who has uploaded the sub-task, provides the required accuracy score. In another embodiment, the required accuracy score is determined based on a complexity of a sub-task. In an embodiment, higher the complexity more is the required accuracy score.

“Remuneration” refers to a payment received by a crowdworker for attempting a task. In an embodiment, the payment can be for completing the whole task or can be for completing one or more sub-tasks contained within the task. In an embodiment, the payment is a monetary compensation received by the crowdworker. However, a person having ordinary skills in the art would understand that the scope of the disclosure is not limited to remunerating monetary compensation to the crowdworker. In an embodiment, various other means of remunerating the crowdworker may be employed such as, remunerating the crowdworkers with lottery tickets, giving gift items, shopping vouchers, and discount coupons. In another embodiment, remuneration may further correspond to strengthening of the relationship between crowdworker and requestor. For example, the requestor may provide access to more tasks so that the crowdworker has more gain. Also, the requestor may modify the per task payment of the crowdworker in order to strengthen the relationship between the requestor and the crowdworker. A person skilled in the art would understand that combination of any of the above mentioned means of remuneration could be used for paying the crowdworker.

“Bonus remuneration” refers to an additional remuneration received by a crowdworker for correctly attempting bonus sub-tasks included in the task.

“Validation” refers to a process of checking whether a response received for a task is correct. In an embodiment, the response for the task can be validated using various known techniques such as by comparing the response received from a crowdworker for a task with responses received from other crowdworkers for the same task. In such a scenario, if the responses for the task from all the crowdworkers are same, the response is validated as a correct response. In another scenario, the responses for the task can be compared with a predetermined correct response for the task to check whether the response received from the crowdworker is correct. A person having ordinary skills in the art would understand that the scope of the disclosure should not be limited to above mentioned techniques to validate a response. In an embodiment, any other known technique can be used or employed to validate the response.

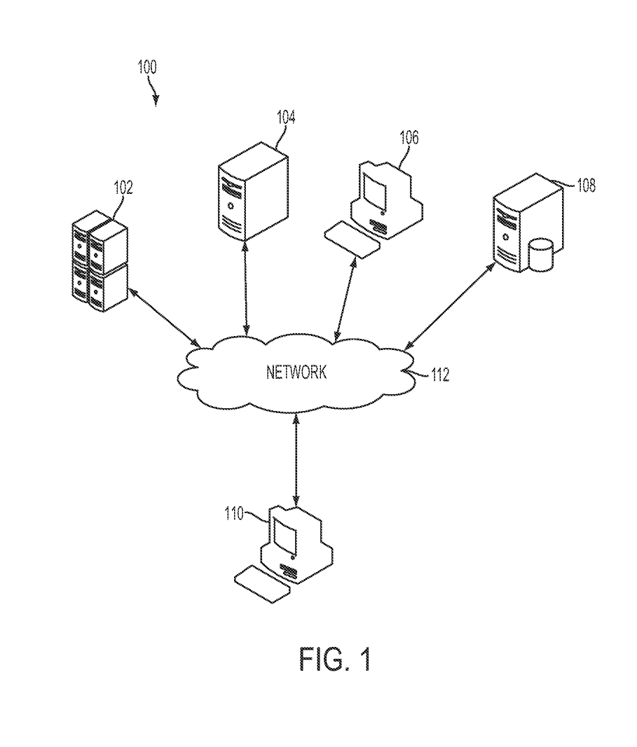

FIG. 1 is a block diagram illustrating a system environment 100 in which various embodiments can be implemented. The system environment 100 includes a crowdsourcing platform server 102, an application server 104, a requestor computing device 106, a database server 108, a crowdworker computing device 110, and a network 112.

The crowdsourcing platform server 102 is operable to host one or more crowdsourcing platforms. One or more crowdworkers are registered with the one or more crowdsourcing platforms. A crowdsourcing platform offers one or more tasks to the one or more crowdworkers. In an embodiment, the crowdsourcing platform may offer a dummy task to the one or more crowdworkers. The dummy task includes a hyperlink or link that directs a crowdworker to the actual task. In an embodiment, the act of clicking on the hyperlink is equivalent to accepting the offer to attempt the task corresponding to the dummy task. In an embodiment, the crowdsourcing platform presents a user interface to the one or more crowdworkers through a web-based interface or a client application. The one or more crowdworkers may access the one or more tasks/dummy tasks through the web-based interface or the client application. Further, the one or more crowdworkers may submit a response for each of the one or more tasks to the crowdsourcing platform through the user interface. In an embodiment, each of the one or more tasks includes one or more sub-tasks. In an embodiment, the crowdsourcing platform server 102 may be realized through an application server, including, but not limited to, Java application server, .NET framework, and Base4 application server.

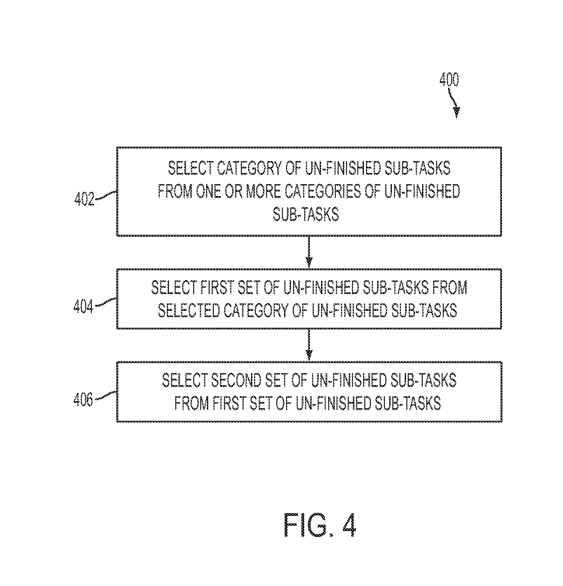

The application server 104 receives a plurality of task requests from the requestor computing device 106. In an embodiment, the plurality of task requests corresponds to a plurality of new sub-tasks. The application server 104 stores the new sub-tasks as a first pool of sub-tasks in the database server 108. When the crowdworker clicks on the hyperlink in the dummy task, the application server 104 receives a notification of this acceptance to attempt the task. On receiving the notification, the application server 104 selects one or more new sub-tasks from the received plurality of new sub-tasks for the purpose of creation of a task. In addition to the selection of the one or more new sub-tasks, the application server 104 selects at least one additional sub-task from a second pool of sub-tasks in the database server 108. In an embodiment, the second pool of sub-tasks includes one or more unfinished sub-tasks. In an embodiment, the unfinished sub-task may correspond to a sub-task of the previously presented task that was at least one of an un-attempted sub-task or a wrongly attempted sub-task. The application server 104 combines the selected one or more new sub-tasks and the at least one additional sub-task to create the task. The selection of the additional sub-task has been described later in conjunction with FIG. 4. Post the creation of the task, the application server 104 presents the task to the crowdworker. In an embodiment, the additional sub-tasks contained in the task are presented as bonus sub-tasks to the crowdworker. Some examples of the application server 104 may include, but not limited to, Java application server, .NET framework, and Base4 application server.

A person having ordinary skills in the art would understand that the scope of the disclosure is not limited to illustrating the application server 104 as a separate entity. In an embodiment, the functionality of the application server 104 may be implementable on/integrated with the crowdsourcing platform server 102.

The requestor computing device 106 is a computing device used by a requestor. In an embodiment, the requestor computing device 106 submits the plurality of task requests to application server 104. In an embodiment, the plurality of task requests corresponds to the plurality of new sub-tasks. Some examples of a sub-task may include, but are not limited to, digitization of a document, generating a report, evaluating a document, conducting a survey, writing a code, extracting data, translating text, and the like. The requestor computing device 106 may be implemented as, but not limited to, a personal computer, a laptop, a personal digital assistant (PDA), a mobile device, a tablet, or any other computing device.

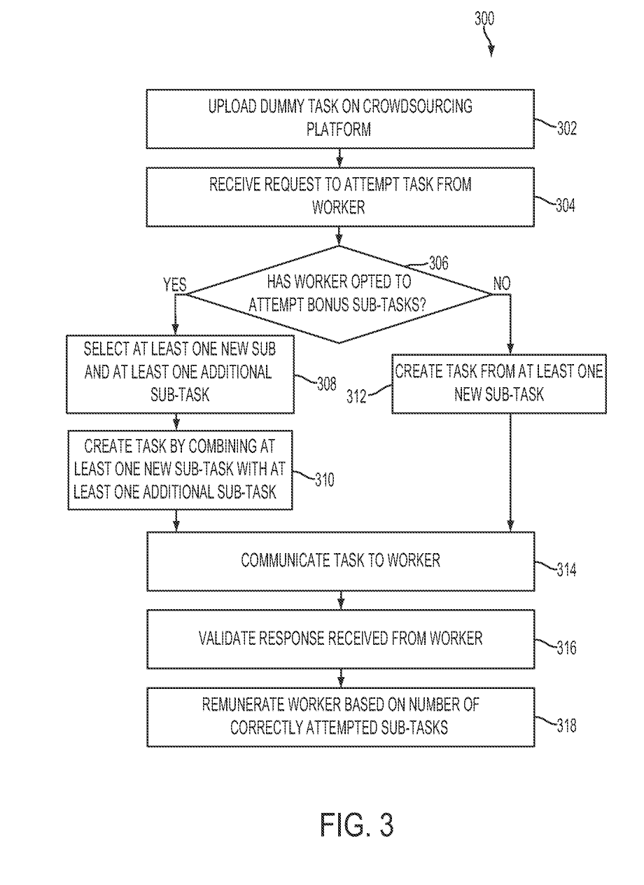

The database server 108 stores information pertaining to the one or more crowdworkers. Further, the database server 108 maintains the first pool of sub-tasks that includes the plurality of new sub-tasks received from the requestor computing device 106. In addition, the database server 108 maintains the second pool of sub-tasks that includes one or more un-finished sub-tasks. The organization of the second pool of sub-task is described later in conjunction with FIG. 3. In an embodiment, the database server 108 may receive a query from at least one of the crowdsourcing platform server 102 or the application server 104 to extract information associated with at least one of the one or more crowdworkers, the plurality of new sub-tasks in the first pool of sub-tasks, or the one or more un-finished sub-tasks in the second pool of sub-tasks. The database server 108 may be realized through various technologies, including, but not limited to, Microsoft® SQL server, Oracle, and My SQL. In an embodiment, the crowdsourcing platform server 102 and/or the application server 104 may connect to the database server 108 using one or more protocols such as, but not limited to, the ODBC protocol and the JDBC protocol.

A person having ordinary skills in the art would understand that the scope of the disclosure is not limited to the database server 108 as a separate entity. In an embodiment, the functionalities of the database server 108 can be integrated into the crowdsourcing platform server 102 and/or the application server 104.

The crowdworker computing device 110 is a computing device used by a crowdworker. The crowdworker computing device 110 is operable to present the user interface (received from the crowdsourcing platform) to the crowdworker. The crowdworker computing device 110 presents the one or more tasks to the crowdworker through the user interface. Thereafter, the crowdworker submits the response for the one or more tasks through the user interface to the crowdsourcing platform. Some examples of the crowdworker computing device 110 include a personal computer, a laptop, a PDA, a mobile device including a mobile phone, a Smartphone, a tablet, or any device that has the capability to display the user interface.

The network 112 corresponds to a medium through which content and messages flow between various devices of the system environment 100 (e.g., the crowdsourcing platform server 102, the application server 104, the requestor computing device 106, the database server 108, and the crowdworker computing device 110). Examples of the network 112 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 112 in accordance with various wired and wireless communication protocols such as Transmission Control Protocol and Internet Protocol (TCP/IP), User Datagram Protocol (UDP), and 2G, 3G, or 4G communication protocols.

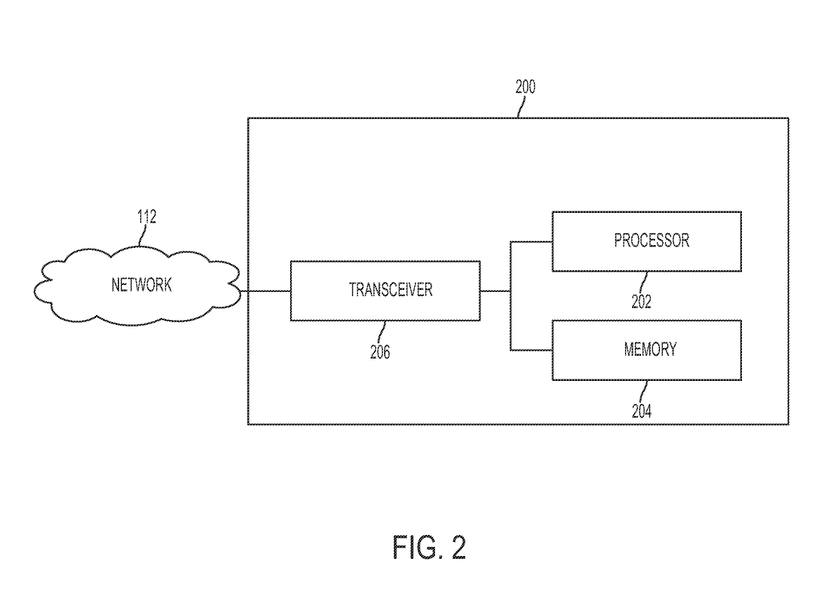

FIG. 2 is a block diagram of a system 200 for creating a task, in accordance with at least one embodiment. The system 200 includes a processor 202, a memory 204, and a transceiver 206. The processor 202 is coupled to the memory 204 and the transceiver 206. The transceiver 206 is connected to the network 112. In an embodiment, the system 200 may correspond to the application server 104. However, a person skilled in the art would appreciate that the system 200 may be implemented as the crowdsourcing platform server 102 or the requestor computing device 106. For the purpose of ongoing description, the system 200 has been considered as the application server 104.

The processor 202 includes suitable logic, circuitry, and/or interfaces that are operable to execute one or more instructions stored in the memory 204 to perform predetermined operations. The memory 204 may be operable to store the one or more instructions. The processor 202 may be implemented using one or more processor technologies known in the art. Examples of the processor 202 include, but are not limited to, an x86 processor, an ARM processor, a Reduced Instruction Set Computing (RISC) processor, an Application-Specific Integrated Circuit (ASIC) processor, a Complex Instruction Set Computing (CISC) processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person having ordinary skills in the art that the one or more instructions stored in the memory 204 enable the hardware of the system 200 to perform the predetermined operations.

The transceiver 206 transmits and receives messages and data to/from various components of the system environment 100 (e.g., the crowdsourcing platform server 102, the requestor computing device 106, the database server 108, and the crowdworker computing device 110) over the network 112. Examples of the transceiver 206 may include, but are not limited to, an antenna, an Ethernet port, a USB port, or any other port that can be configured to receive and transmit data. The transceiver 206 transmits and receives data/messages in accordance with the various communication protocols, such as TCP/IP, UDP, and 2G, 3G, or 4G.

The operation of the system 200 for creating the one or more tasks has been described in conjunction with FIG. 3.

FIG. 3 is a flowchart 300 illustrating a method for creating a task, in accordance with at least one embodiment. The flowchart 300 has been described in conjunction with FIG. 1 and FIG. 2.

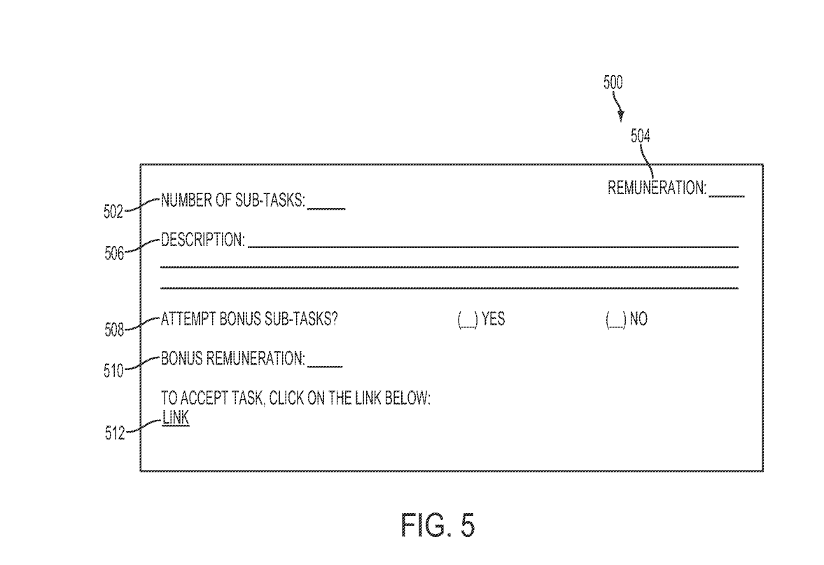

At step 302, a dummy task is uploaded on to the crowdsourcing platform. In an embodiment, the processor 202 is operable to upload the dummy task on to the crowdsourcing platform. The dummy task corresponds to an actual task that can be accessed by clicking on the hyperlink. Further, the dummy task includes a description of the task, remuneration associated with the task, a number of sub-tasks present in the task, and type of sub-tasks present in the task. In addition, the dummy task includes an option that is presented to the crowdworker to attempt one or more bonus sub-tasks. Also, included in the option is the additional remuneration that the crowdworker may receive by attempting the one or more bonus sub-tasks. The structure of the dummy task has been described later in conjunction with FIG. 5.

The crowdsourcing platform presents the dummy task to the one or more crowdworkers. Crowdworkers, who wish to attempt the task corresponding to the dummy task, click on the hyperlink in the dummy task. In an embodiment, some of the crowdworkers select the option to attempt the one or more bonus sub-tasks. When a crowdworker clicks on the hyperlink, the crowdworker computing device 110 transmits a notification to the application server 104. In an embodiment, the notification may be indicative of a request to attempt the task. Further, the notification includes an identification of the crowdworker who has clicked on the hyperlink, and information pertaining to whether the crowdworker has selected the option to attempt the one or more bonus sub-tasks.

At step 304, a request to attempt the task is received via the means of the notification. In an embodiment, the processor 202 receives the request from the crowdworker computing device 110 through the transceiver 208.

At step 306, a check is performed to determine whether the crowdworker has selected the option to attempt the bonus sub-tasks. In an embodiment, the processor 202 performs the check. If at step 306, the processor 202 determines that the option to attempt the one or more bonus tasks has been opted by the crowdworker, step 308 is performed.

At step 308, at least one new sub-task and at least one additional sub-task is selected from the first pool of sub-tasks and the second pool of sub-tasks respectively. In an embodiment, the processor 202 is operable to select the at least one new sub-task and the at least one additional sub-task.

Initially, when the system 200 operates for the first time, the second pool of sub-tasks does not include any unfinished sub-tasks. Thus, the processor 202 utilizes the new sub-tasks from the first pool of sub-tasks for the purpose of creation of the task. In an embodiment, the processor 202 selects the new sub-tasks based on the type of the sub-tasks or a remuneration associated with each sub-task in the first pool of sub-tasks. For example, the processor 202 may select a predetermined number of new sub-tasks of the same type from the first pool of sub-tasks. For instance, each of the selected new sub-tasks pertains to digitization of a handwritten document. Following table illustrates an organization of the first pool sub-tasks:

TABLE 1
Organization of the first pool of sub-tasks

| Sub-tasks | Type | Remuneration (USD) |
|---|---|---|
| Sub-task1 | Document digitization | 0.5 |
| Sub-task2 | Image processing | 2 |
| Sub-task3 | Document digitization | 0.8 |
| Sub-task4 | Image processing | 3 |
| Sub-task5 | Document digitization | 2 |

Referring to Table 1, for selecting the new sub-tasks, the processor 202 determines a type of the new sub-tasks present in the first pool of sub-tasks. In addition, the processor 202 determines the remuneration associated with each new sub-task. For instance, the processor 202 determines that the “Sub-task1” pertains to document digitization and has a remuneration of “0.5 USD” associated with it. Thereafter, the processor 202 collates the predetermined number of the new sub-tasks of same type to create the task. For example, the processor 202 may create a task that includes the “Sub-task1” and the “Sub-task3”, as both the sub-tasks corresponds to document digitization. Similarly, the processor 202 may select the new sub-tasks based on the associated remuneration value to create the task.

A person having ordinary skills in the art would understand that the scope of the disclosure is not limited to selecting the new sub-task based on the type and the respective remunerations. In an embodiment, the new sub-tasks can be selected based on the expertise possessed by the crowdworkers, competency score associated with the crowdworkers, etc.

Post the creation of the task, the processor 202 transmits the task to the crowdworkers who opted to attempt the task. Thereafter, a response for the task is received by the processor 202 through the transceiver 208. In an embodiment, the response includes responses for the new sub-tasks contained in the task. The processor 202 is operable to validate the responses for the new sub-tasks. In order to validate, the processor 202 compares the responses received from each of the crowdworkers for each of the new sub-tasks with one another to determine whether the consensus on the responses has been achieved. If the processor 202 determines that the consensus on the responses for the new sub-tasks has been achieved, the processor 202 marks each of the new sub-tasks as finished. If the processor 202 determines that the consensus for the at least one new sub-task has not been achieved, the processor 202 marks the at least one new sub-task as an unfinished sub-task. Further, the processor 202 stores the at least one new sub-task, marked as the unfinished sub-task, in the second pool of sub-tasks. In another scenario, the crowdworkers may have intentionally or un-intentionally not attempted the at least one sub-task. For example, the presented task includes five sub-tasks pertaining to digitization of a handwritten document. Out of the five sub-tasks, the crowdworker may have attempted only four sub-tasks and considering that the four sub-tasks have been correctly attempted by the crowdworkers (determined based on validation of the sub-tasks described in step 316). The fifth sub-task may remain un-attempted by the one or more crowdworkers due to certain constraints such as, but not limited to, incomplete information, ambiguous data in the sub-task, less than expected remuneration for the sub-task, and the like. The processor 202 marks such sub-tasks as unfinished and stores such sub-tasks in the second pool of sub-tasks in the database server 108.

Therefore, the second pool of sub-tasks includes those sub-tasks that have been marked as unfinished by the processor 202 due to the reason set forth above. In an embodiment, processor 202 categorizes each of the unfinished sub-tasks into one or more categories based on a number of times the sub-task has been attempted or presented to the crowdworkers. Following table illustrates an example scenario of categorization of the unfinished sub-tasks in the one or more categories:

TABLE 2
Categorization of unfinished tasks

| Sub-task | Number of attempts | Category |
|---|---|---|
| Sub-task1 | 3 | Category 3 |
| Sub-task2 | 5 | Category 5 |
| Sub-task3 | 2 | Category 2 |
| Sub-task4 | 3 | Category 3 |

Referring to Table 2, it can be observed that three previous attempts have been made by the crowdworkers to complete the unfinished sub-task1 and the unfinished sub-task4. Therefore, the processor 202 categorizes the unfinished sub-task1 and the unfinished sub-task4 in the category 3. Similarly, as five attempts have been made by the crowdworkers to complete the Sub-task2, the Sub-task2 has been categorized in Category 5. In an embodiment, the processor 202 modifies the category of the unfinished sub-task with each unsuccessful attempt to complete the sub-task. For example, if the unfinished Sub-task1 is again presented to the crowdworker and again the consensus on the responses for the unfinished Sub-task1 is not achieved, the number of attempts made by the crowdworkers gets incremented to four and the unfinished Sub-task1 is categorized in Category 4. In an embodiment, the category in which the unfinished sub-task has been categorized is indicative of complexity of the sub-task. For example, an unfinished sub-task categorized in the “Category 5” is more complex than an unfinished sub-task categorized in the “Category 3”, as the number of times the unfinished sub-task in Category 5 has been unsuccessfully attempted is more than the number of times the sub-task in category 3 has been unsuccessfully attempted.

In an embodiment, a number of times an unfinished sub-task can be attempted are limited to a pre-defined number. If the number of unsuccessful attempts made to complete an unfinished sub-task is more than the predefined number, the unfinished sub-task is removed from the second pool of sub-tasks and is sent to an internal team for completion. In an embodiment, the number of categories in the one or more categories is also limited to the pre-defined number.

A person having ordinary skills in the art would understand that the scope of the disclosure is not limited categorizing the unfinished sub-tasks based on the number of times the unfinished sub-task has been wrongly attempted. In an embodiment, the unfinished sub-tasks can be categorized based on the priority of an unfinished sub-task. For instance, the requestor may have inputted the priority of the sub-task while sending the task request to the application server 104. Initially, when the sub-task does not get completed and is moved to the second pool of sub-tasks, the sub-task is categorized in the one or more categories based on the priority. For example, a sub-task with a higher priority, which is wrongly attempted by the crowdworkers, may be categorized in a category having a higher required accuracy range.

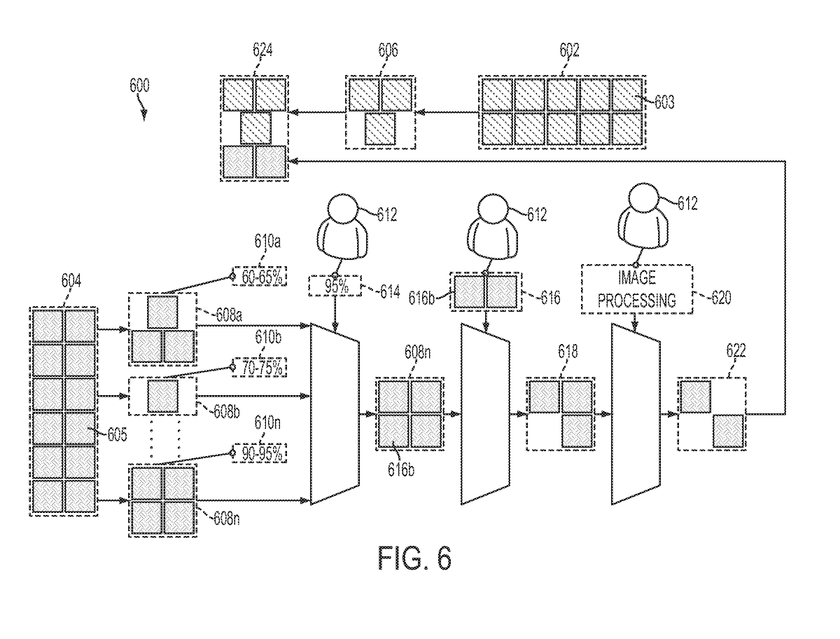

Referring again to step 308, the processor 202 selects the at least one new sub-task and the at least one additional sub-task from the first pool of sub-tasks and the second pool of sub-tasks, respectively. As described above, the processor 202 selects the at least one new sub-task from the first pool of sub-task. In addition, the processor 202 selects the at least one additional sub-task from the second pool of sub-tasks. In order to select the at least one additional sub-task, the processor 202 extracts the profiles of the crowdworkers who have opted to attempt the bonus sub-tasks. In an embodiment, the processor 202 may utilize the identification number associated with the crowdworker (included in the notification received in the step 304) to extract the profile from the database server 108. Further, the processor 202 determines one or more parameters associated with each unfinished sub-task in the second pool of sub-tasks. Based on the one or more parameters and the profiles of the crowdworkers, the processor 202 selects the at least one additional sub-task from the second pool of sub-tasks. The selection of the at least one additional sub-task has been described later in conjunction with FIG. 4 and FIG. 6.

At step 310, the at least one new sub-task and the at least one additional sub-task are combined together to create a task. In an embodiment, the created task has two portions, the first portion includes the at least one new sub-task, and the second portion includes the at least one additional sub-task. In an embodiment, the at least one additional sub-task in the task is referred as the bonus sub-task.

If at step 306, the processor 202 determines that the crowdworker has not opted for the bonus sub-task, step 312 is performed. At step 312, the at least one new sub-task is selected for creating the task. In an embodiment, the processor 202 selects the at least one new sub-task from the first pool of sub-tasks as described above in conjunction with step 308. The task created in such a scenario only includes the at least one new sub-task.

At step 314, the task is communicated to the crowdworker. In an embodiment, the processor 202 is operable to communicate the task to the crowdworker through the transceiver 208. In an alternate embodiment, the task is not communicated to the crowdworker. Instead, the crowdworker is directed to a webpage being hosted by the application server 104. The crowdworker may access the task through the webpage. The crowdworker may attempt the task by attempting the sub-tasks present in the task. Further, the crowdworker may also attempt the bonus sub-tasks (i.e., the additional sub-task) included in the task. Post attempting the task, the crowdworker transmits the response for the task to the application server 104. In the application server 104, the processor 202 is operable to receive the response for the task from each of the crowdworkers. In an embodiment, the response for the task includes sub-responses for each sub-task (the new sub-task and the additional sub-task) included in the task.

At step 316, the responses received for the task from the crowdworkers are validated. In an embodiment, the processor 202 validates the responses received from the crowdworkers. Each response includes one or more sub-responses for each of the one or more sub-tasks contained in the task. Firstly, the processor 202 performs a check to determine whether a sub-response, in a response received from a crowdworker, is for a new sub-task or for an additional sub-task. If the processor 202 determines that the sub-response is for the new sub-task, the processor 202 determines other sub-responses received for the new sub-task from other crowdworkers. Thereafter, the processor 202 compares the sub-responses received for the new sub-task with one another to determine whether the consensus on the sub-response for the new sub-task is achieved. If the consensus on the sub-response for the new sub-task is achieved, the processor 202 marks the new sub-task as complete. Else, the processor 202 considers the new sub-task as wrongly attempted.

If the processor 202 determines that the sub-response is for the additional sub-task that was selected from the second pool of sub-tasks, the processor 202 extracts the previous sub-responses received for the additional sub-task from the database server 108. A person having ordinary skills in the art would understand that as the additional sub-task corresponds to an unfinished sub-task from the second pool of sub-tasks, there exists a repository of previously received sub-responses for the additional sub-task that is used for the validation purposes. Thereafter, the processor 202 compares the current sub-response received for the additional sub-task with the previous sub-responses received for the additional sub-task to determine whether the consensus is achieved. If the consensus is achieved, the processor 202 marks the additional sub-task as complete. If the consensus for the additional sub-task is not achieved, the processor 202 increments the number of unsuccessful attempts by one and accordingly modifies the category of the additional sub-task as discussed in step 308.

In addition to validating the new sub-task and the additional sub-task, the processor 202 identifies the sub-task for which no sub-responses were included in the responses received for the task from each crowdworker. The processor 202 marks such sub-tasks as unfinished sub-tasks.

At step 318, the crowdworkers are remunerated. In an embodiment, the processor 202 releases the remuneration to the crowdworkers. Prior to releasing the remuneration, the processor 202 determines the sub-tasks that each crowdworker has correctly attempted. Based on the number of correctly attempted sub-tasks, the crowdworker is remunerated. If the crowdworker has correctly attempted bonus sub-tasks (i.e., unfinished sub-tasks), the crowdworker is accordingly remunerated.

FIG. 4 is a flowchart 400 illustrating a method to select an additional task from a pool of sub-tasks, in accordance with at least one embodiment. The flowchart 400 is described in conjunction with FIG. 1, FIG. 2, and FIG. 3.

As discussed in conjunction with FIG. 3, the unfinished sub-tasks in the second pool of sub-tasks are categorized in the one or more categories based on the number of times an unfinished sub-task has been previously attempted. Further, as discussed above, each of the one or more categories is indicative of the complexity of the unfinished sub-tasks contained within. In order to attempt a complex unfinished sub-task, a crowdworker having high competency score may be selected. Therefore, the processor 202 defines a required accuracy score range for each of the one or more categories based on the complexity of the unfinished sub-tasks contained within. In an embodiment, the processor 202 may utilize following mathematical relation to determine the required accuracy range:

R∝k (1)

where,

R: Range of required accuracy score for a category; and

k: complexity of an unfinished sub-task in the category.

In another embodiment, the required accuracy score range for each of the one or more categories is pre-determined or is inputted by the administrator of the system 200. Following table illustrates an example of the required accuracy score range associated with each of the one or more categories:

TABLE 3
One or more categories and corresponding required accuracy score range

| Categories | Required Accuracy Scores Range |
|---|---|
| Category-1 | 65%-69% |
| Category-2 | 70%-87% |
| Category-3 | 88%-95% |
| Category-4 | 96%-99% |

At step 402, a category is selected from the one or more categories for each of the one or more crowdworkers based on the competency score associated of each of the one or more crowdworkers. In an embodiment, the processor 202 is operable to select the category. The processor 202 extracts the competency score associated with each of the one or more crowdworkers from the database server 108. In addition, the processor 202 determines the required accuracy score range for each of the one or more categories. Thereafter, based on the competency score associated with the one or more crowdworkers and the required accuracy score range associated with each of the one or more categories, the processor 202 selects a category from the one or more categories for each of the one or more crowdworkers. For example, following table illustrates competency scores associated with the one or more crowdworkers, respectively:

TABLE 4
One or more crowdworkers and associated competency scores

| Crowdworkers | Competency scores |
|---|---|
| Crowdworker-1 | 69% |
| Crowdworker-2 | 87% |
| Crowdworker-3 | 99% |

Referring to Table 3 and Table 4, the accuracy score range required to attempt the unfinished sub-tasks in the category 1 is 65%-69%. Thus, any crowdworker having a competency score in the range of 65% to 69% can attempt the unfinished sub-tasks in the Category-1. Therefore, the processor 202 may select the Category-1 for the Crowdworker-1, as the competency score of the Crowdworker-1 is 69%. Similarly, the processor 202 may select the Category-4 for the Crowdworker-3, as the competency score of the Crowdworker-3 (i.e., 99%) is within the required accuracy score range for the Category-4 (i.e., 96%-99%).

A person having ordinary skills in the art would understand that the category selected in the step 402 is selected for a crowdworker depending on the competency score of the crowdworker. As the competency score varies from crowdworker to crowdworker, the category selected for each crowdworker is different. At step 404, a first set of unfinished sub-tasks is selected from the unfinished sub-tasks contained in the selected category. In an embodiment, the processor 202 selects the first set of unfinished sub-tasks. To select the first set of unfinished sub-tasks, the processor 202 extracts the profile, of the crowdworker for whom the category has been selected, from the database server 108. In an embodiment, the profile of the crowdworker includes information pertaining to the sub-tasks that the crowdworker has previously attempted. Based on the sub-tasks that the crowdworker has previously attempted, the processor 202 selects the first set of unfinished sub-tasks from the selected category such that the crowdworker has not previously attempted the sub-tasks contained in the first set of unfinished sub-tasks. The step 404 is described later in conjunction with FIG. 6.

At step 406, a second set of unfinished sub-tasks is selected from the first set of unfinished sub-tasks based on the type of each unfinished sub-task in the first set of unfinished sub-tasks. In an embodiment, the processor 202 selects the second set of unfinished sub-tasks. The processor 202 determines an expertise of the crowdworker for whom the first set unfinished sub-tasks has been extracted. Thereafter, based on the expertise of the crowdworker and the type of the unfinished sub-tasks in the first set of unfinished sub-tasks, the processor 202 selects the second set of unfinished sub-tasks from the first set of unfinished sub-tasks. Following table illustrates an example of the types of sub-tasks in the first set of unfinished sub-tasks:

TABLE 5
Type of sub-tasks in the first set of unfinished sub-tasks

| Unfinished Sub-task in the first | |
|---|---|
| set of unfinished sub-tasks | Type of sub-tasks |
| Sub-task1 | Document digitization |
| Sub-task2 | Anomaly detection |
| Sub-task3 | Image processing |

For example, the crowdworker for which the first set of unfinished sub-tasks has been selected possesses the expertise in image processing and document digitization. Therefore, the processor 202 will select Sub-task1 and Sub-task3 as the second set of unfinished sub-tasks.

The processor 202 will include the selected second set of unfinished sub-tasks in the task created in the step 310 as the additional sub-tasks.

A person having ordinary skills in the art would understand that the scope of the disclosure is not limited to the order of the steps performed in the flowchart 400. In an embodiment, steps in the flowchart 400 can performed in any possible order.

In an embodiment, the method disclosed for selecting the unfinished sub-tasks from the second pool of unfinished sub-tasks can be implemented for selecting a new sub-task from the first pool of sub-tasks. In such a scenario, the new sub-tasks in the first pool of sub-tasks are categorized in the one or more categories based on the required accuracy score range inputted by the requestor at the time of submission of the sub-tasks. Thereafter, steps 402 and 406 can be performed to select the new sub-tasks from the first pool of subtasks. As the crowdworker has not previously attempted any of the new sub-tasks, step 404 is redundant and therefore is not performed.

FIG. 5 is a snapshot of a dummy task 500, in accordance with at least one embodiment. The dummy task 500 includes a number of sub-tasks field 502, a remuneration field 504, a task description field 506, an option 508, a remuneration associated with bonus sub-tasks 510, and a link 512.

The dummy task 500 presents the number of sub-tasks field 502 is indicative of the number of sub-tasks that will be included in the task. The remuneration field 504 illustrates a remuneration or payment that a crowdworker may receive on completing the sub-tasks. The task description field 506 includes a write-up of the type of task that the crowdworkers have in hand. The option field 508 presents an option to the crowdworker to attempt bonus sub-tasks. In addition, the dummy task 500 displays the remuneration that the crowdworker will receive for attempting the bonus tasks (depicted by 510). Finally, the dummy task 500 includes the link 512 that the crowdworker may have to click to attempt the task corresponding to the dummy task 500.

FIG. 6 is a flow diagram 600 illustrating the process of creation of the task, in accordance with at least one embodiment. The flow diagram 600 is described in conjunction with FIG. 1, FIG. 2, FIG. 3, and FIG. 4.

The flow diagram 600 illustrates a first pool of sub-tasks 602 and a second pool of sub-tasks 604. The first pool of sub-tasks 602 includes one or more new sub-tasks 603 and the second pool of sub-tasks includes one or more unfinished sub-tasks 605. As described in conjunction with step 308, the processor 202 selects a predetermined number of new sub-tasks (depicted by 606) from the first pool of sub-tasks.

The unfinished sub-tasks in the second pool of sub-tasks 604 are further categorized in the one or more categories (depicted by 608a, 608b, . . . , 608n) based on the complexity of the unfinished sub-tasks. In an embodiment, the complexity of a sub-task can be determined based on a number of times a sub-task has been attempted unsuccessfully. In an embodiment, the category 608a includes unfinished sub-tasks that have been unsuccessfully attempted once. Similarly, the category 608n includes unfinished sub-tasks that have been unsuccessfully attempted by the crowdworkers n times before the current instance. In an embodiment, the accuracy that a crowdworker must posses to attempt the unfinished sub-tasks of category 608n is more in comparison to the accuracy that a crowdworker must posses to attempt the unfinished sub-tasks of category 608a. Each of the one or more categories (depicted by 608a, 608b, . . . , 608n) has an associated required accuracy score range (depicted by 610a, 610b, . . . , 610n respectively). The required accuracy score range is the accuracy that a crowdworker must posses in order to attempt respective unfinished sub-tasks.

For instance, a crowdworker (depicted by 612) having a competency score of 95% (depicted by 614) wishes to attempt the unfinished sub-tasks. As the competency score of 95% is at par to attempt the unfinished sub-tasks contained in the category 608n, the processor 202 will select the category 608n.

Thereafter, the processor 202 determines the one or more sub-tasks that the crowdworker 612 has previously worked on (depicted by 616). Thereafter, the processor 202 selects the first set of unfinished sub-tasks from the sub-tasks present in the category 608n by filtering out the sub-tasks that the crowdworker 612 has previously worked on (depicted by 616). For instance, the crowdworker has worked on the sub-task 616b previously. The sub-task 616b is also present in the category 608n. Therefore, the processor 202 will filter out the sub-task 616b from the category 608n and the remaining sub-tasks in the category 608n will constitute the first set of unfinished sub-tasks (depicted by 618).

From the first set unfinished sub-tasks 618, the processor 202 selects the second set of unfinished sub-tasks 622 (as described in step 406). For instance, the crowdworker 612 is proficient in image processing (depicted by 620). The processor 202 will select those unfinished sub-tasks that correspond to the field of image processing (depicted by 620). Such sub-tasks will constitute the second set of unfinished sub-tasks (depicted by 622). Thereafter, the processor 202 combines the second set of unfinished sub-tasks 622 with the predetermined number of new sub-tasks 606 to create the task 624.

A person having ordinary skills in the art would understand that the scope of the disclosure is not limited to creating the tasks based on requestor's requirements. In an embodiment, the creation of the task can be tweaked as per business requirements. For example, the number of categories in the one or more categories (i.e., categories in which the unfinished sub-tasks have been categorized) can vary based on business requirements.

The disclosed embodiments encompass numerous advantages. The crowdworker is presented a dummy task instead of a complete task. In the dummy task, the crowdworker is presented with an option to attempt bonus sub-tasks. If the crowdworker selects the option to attempt the bonus sub-tasks, the application server 104 appends unfinished sub-tasks from the previously attempted sub-tasks to the new task. Therefore, the backlog of the unfinished sub-tasks is reduced drastically in comparison to the solutions available in the prior art. In addition, the crowdworkers are remunerated for the extra sub-tasks that they have attempted. Further, an unfinished sub-task is selected in such a manner that the crowdworker attempting the unfinished sub-task is attempting the sub-task for the first time. If the crowdworker has previously attempted the sub-task, the sub-task is not presented to the crowdworker. Thus, disclosed system ensures that the same sub-task is not sent to a crowdworker again. Additionally, if the crowdworker correctly attempts the bonus tasks included in the task, the crowdworker receives extra remuneration for the correctly attempting the bonus tasks. Thus, the bonus remuneration may lure more crowdworkers to attempt the task.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for creating one or more tasks have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for creating a task, the method comprising:
receiving, by one or more processors, a request from a worker to perform the task;
creating, by the one or more processors, the task in response to the request, wherein the task comprises at least one new sub-task and at least one additional sub-task, wherein the at least one additional sub-task is selected from a set of unfinished sub-tasks associated with one or more previously attempted tasks; and
communicating, by the one or more processors, the task to the worker, wherein the worker receives a bonus remuneration for correctly attempting the at least one additional sub-task.

2. The method of claim 1, wherein the set of unfinished sub-tasks comprises at least one of one or more un-attempted sub-tasks, or one or more wrongly attempted sub-tasks.

3. The method of claim 1, wherein attempting the at least one additional sub-task by the worker is optional.

4. The method of claim 1, wherein the at least one additional sub-task is presented as a bonus task to the worker.

5. The method of claim 1 further comprising validating, by the one or more processors, responses received from the worker for the at least one additional sub-task and the at least one new sub-task.

6. The method of claim 5 further comprising identifying, by the one or more processors, at least one of one or more wrongly attempted sub-tasks or one or more un-attempted sub-tasks based on the validation.

7. The method of claim 6 further comprising storing, by the one or more processors, the identified one or more wrongly attempted sub-tasks and the one or more un-attempted sub-tasks in the set of unfinished sub-tasks.

8. The method of claim 1 further comprising categorizing, by the one or more processors, the set of unfinished sub-tasks in one or more categories based on at least one of a task complexity or a task priority.

9. The method of claim 1 further comprising selecting, by the one or more processors, the at least one additional sub-task from the set of unfinished sub-tasks based on at least one of a check whether the worker has previously attempted the at least one additional sub-task, a competency score achieved by the worker on attempting the previously presented tasks, or a semantic associated with the at least one additional sub-task.

10. A system for creating a task, the system comprising:
one or more processors operable to:
receive a request from a worker to perform the task;
create the task, in response to the request, wherein the task comprises at least one new sub-task and at least one additional sub-task, wherein the at least one additional sub-task is selected from a set of unfinished sub-tasks associated with one or more previously attempted tasks; and
communicate the task to the worker, wherein the worker receives a bonus remuneration for correctly attempting the at least one additional sub-task.

11. The system of claim 10, wherein the set of unfinished sub-tasks comprises at least one of one or more un-attempted sub-tasks, or one or more wrongly attempted sub-tasks.

12. The system of claim 10, wherein the at least one additional sub-task is presented as a bonus task to the worker.

13. The system of claim 10, wherein the one or more processors are further operable to validate responses received from the worker for the at least one additional sub-task and the at least one new sub-task.

14. The system of claim 13, wherein the one or more processors are further operable to identify at least one of one or more wrongly attempted sub-tasks or one or more un-attempted sub-tasks based on the validation.

15. The system of claim 14, wherein the one or more processors are further operable to store the identified one or more wrongly attempted sub-tasks and the one or more un-attempted sub-tasks in the set of unfinished sub-tasks.

16. The system of claim 10, wherein the one or more processors are further operable to categorize the set of unfinished sub-tasks in one or more categories based on at least one of a task complexity or a task priority.

17. The system of claim 10, wherein the one or more processors are further operable to select the at least one additional sub-task from the set of unfinished sub-tasks based on at least one of a check whether the worker has previously attempted the at least one additional sub-task, a competency score achieved by the worker on attempting the previously presented tasks, or a semantic associated with the at least one additional sub-task.

18. A computer program product for use with a computing device, the computer program product comprising a non-transitory computer readable medium, the non-transitory computer readable medium stores a computer program code for creating a task, the computer program code is executable by one or more processors in the computing device to:
receive a request from a worker to perform the task;
create the task, in response to the request, wherein the task comprises at least one new sub-task and at least one additional sub-task, wherein the at least one additional sub-task is selected from a set of unfinished sub-tasks associated with one or more previously attempted tasks; and
communicate the task to the worker, the worker receives a bonus remuneration for correctly attempting the at least one additional sub-task.

19. The computer program product of claim 18, wherein computer program code is further executable by the one or more processors in the computing device to categorize the set of unfinished sub-tasks in one or more categories.

20. The computer program product of claim 18, wherein computer program code is further executable by the one or more processors in the computing device to the at least one additional sub-task from the set of unfinished sub-tasks based on at least one of a check whether the worker has previously attempted the at least one additional sub-task, a competency score achieved by the worker attempting on the previously presented tasks, or a semantic associated with the at least one additional sub-task.
